(19) United States
(12) Patent Application Publication
(10) Pub. No.: US 2008/0151692 A1
(43) Pub. Date: Jun. 26, 2008

(54) Low Cost Acoustic Responder Location System

(75) Inventors: Esko Olavi Dijk, 'S-Hertogenbosch (NL); Cornelis Hermanus Van Berkel, Heeze (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN, NETHERLANDS (NL)

(21) Appl. No.: 11/572,599

(22) PCT Filed: Jul. 20, 2005
(86) PCT No.: PCT/IB05/52437

§ 371 Date: Jan. 24, 2007

Related U.S. Application Data
(60) Provisional application No. 60/591,074, filed on Jul. 26, 2004.
(60) Provisional application No. 60/632,622, filed on Dec. 2, 2004.

(51) Int. Cl. G01S 15/74

(52) U.S. Cl. 367/127

(57) ABSTRACT

A location system including a base station (120, 200) and a responder tag (140, 250) that communicate using an acoustic signal to determine the location of the tag in a bounded 3D space (100). The base station transmits a request signal (310) encoded with the identifier of a particular tag. The particular tag responds after a fixed delay (t2−t1) with an acoustic response signal (330). The base station determines the location of the tag based on the received line of sight signal (330) and its reflections (340). The response signal may be encoded with data indicating a status of the tag, or data from associated sensors (270) or actuators (280). The request signal may also be encoded with data for controlling the tag or the associated sensors and actuators. A power management scheme may be carried out by the tag.

This application claims the benefit of U.S. provisional patent application No. 60/591,074, filed Jul. 26, 2004 (docket no. US040311), incorporated herein by reference.

The invention relates generally to a location system for locating objects in a room, and more particularly, to a location system using acoustic, including ultrasonic, wireless signals in a request-response scheme.

Various approaches have been developed for detecting the location of objects. For example, global positioning system (GPS) receivers haven been provided in vehicle and hand held devices to determine location. Location technologies are also increasingly found in applications such as real-time inventory control, asset tracking, sports, mobile robotics, virtual reality and motion capture, and security systems. A location system can measure the location of a person, device, animal, or object with an accuracy that may vary from meters to kilometers. Some location systems measure the orientation of an object as well. Moreover, acoustic systems have been used in underwater position estimation (e.g. military, sonar, underwater navigation, and ocean-biology applications).

For indoor applications, the GPS and underwater approaches are not suitable. Instead, various indoor location-measuring approaches have been proposed. For example, RF-ID transponder systems operate using a request-response scheme. Other approaches use an RF request with an acoustic response. However, the prior approaches have not been well suited for providing a low cost location system.

The present invention addresses the above and other issues by providing an acoustic request-response scheme where a base station requests a response from a responder tag by transmitting an acoustic signal to the tag, and the tag responds by transmitting its own ultrasonic signal. The base station and responder tag are used in an indoor location such as a room, such that reflections of the acoustic signal transmitted by the responder tag are used in determining the location of the responder tag in the room.

In particular, in one aspect of the invention, a location system includes a base signal, the timer of the responder tag is responsive to receipt of the first wireless signal for determining when a predefined period of time has elapsed since the receipt of the first wireless signal, and the transmitter of the responder tag is responsive to the timer of the responder tag for transmitting a second acoustic wireless signal after the predefined period of time has elapsed. The second wireless signal, and reflections thereof within the at least partially bounded 3D space, are received by the receiver of the base station at different times, and a location of the responder tag in the at least partially bounded 3D space is determined, using the timer of the base station, and based on times of receipt of the second wireless signal, and the reflections thereof.

A corresponding base station, responder tag and program storage device may also be provided.

In the drawings:

In all the Figures, corresponding parts are referenced by the same reference numerals.

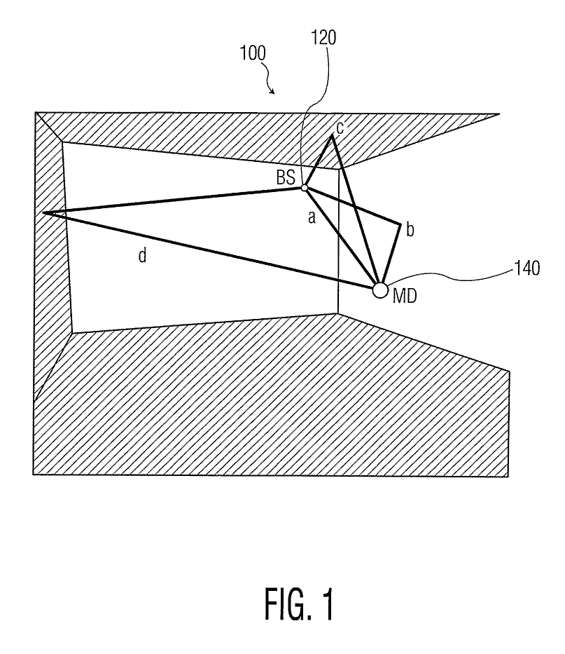

FIG. 1 illustrates a diagram of a location system in a room, according to the invention;

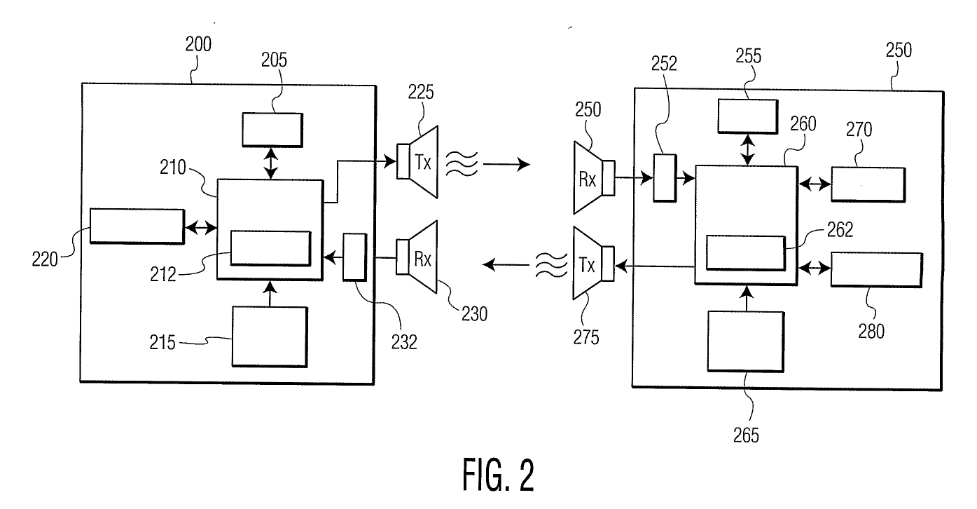

FIG. 2 illustrates a block diagram of a base station and a responder tag, according to the invention;

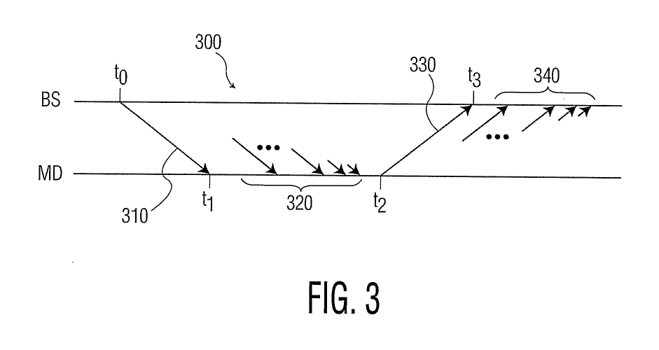

FIG. 3 illustrates a timing diagram for acoustic signals transmitted by the base station and the responder tag of FIG. 2, according to the invention;

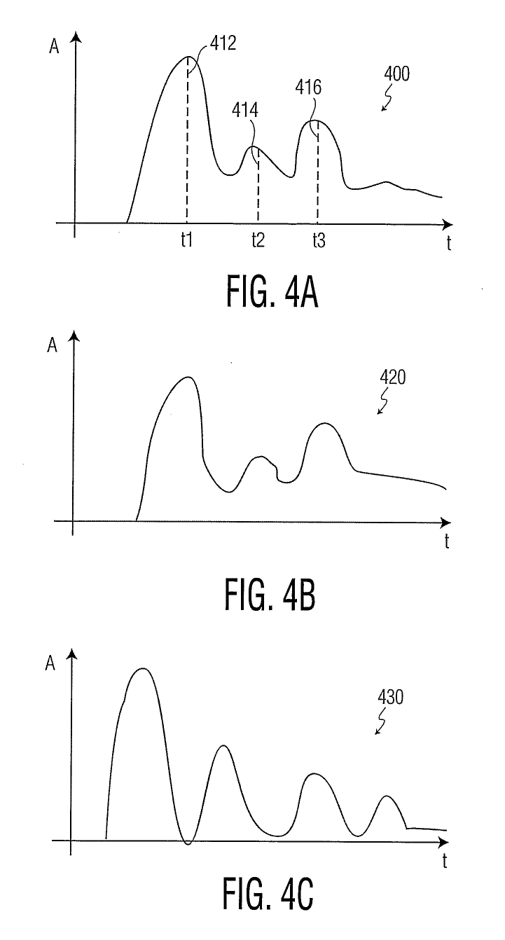

FIG. 4a illustrates an ultrasound signal as detected by a base station receiver, according to the invention;

FIG. 4b illustrates a first signal template, according to the invention; and

FIG. 4c illustrates a second signal template, according to the invention.

FIG. 1 illustrates a diagram of a location system in a room 100, according to the invention. The room in which the location system is provided can be considered to be a 3D space that is at least partially bounded, e.g., by walls, a ceiling and a floor. A base station (BS) 120 is mounted at a fixed position in the room, preferably at a high location so that there is an uninterrupted line of sight between the base station and the likely locations of the responder tag or mobile device (MD) 140. The responder tag can be attached to, or otherwise be part of, an object whose location is to be determined. Furthermore, the object can have sensors and/or actuators. The location system can be used for a number of different applications, examples of which are as follows.
1. Security systems. One example involves sensor tags that register motion and position (doors/windows opening), or vibrations (glass shattering), or objects being moved (position and motion). The fact that the position of the tags is known makes such a security system easier to configure. For the objects-moved case, the base station can assess where the object is taken and whether that is allowed. If the movement is unauthorized, the base station can sound an alarm.
2. Ambient Intelligent user interfaces. Examples include:
   a. Interactive table surface ‘screen’ where users can move around small objects having tags, whose positions are used to control the interactive application. Can be used for board games and the like.
   b. Interactive wall ‘whiteboard’ where users can move around small magnets having tags. Their positions are used to call up information on the whiteboard screen.
   c. Ambient object user interfaces, where the position of certain objects in the room controls the light and mood settings.
   d. Light control. Moving, e.g., three tags relative to each other on a table changes the light color and mood.
3. Gaming
   a. Interactive board games
   b. Games for children—the position of special objects having tags (e.g., action figures) in the room determines the story-line of an interactive story or game running on a personal computer (PC) or on a large screen in the room
   c. Hide and seek game for children.
4. Finding missing objects—a system can tell a user where important objects such as a key ring, remote control device, purse, and so forth, are currently located, or where they were last detected if they cannot be currently located, e.g., due to being removed from the room.
5. Alzheimer patients care—a system can track the location of patients that wander off, and possibly take action, e.g., close doors when they approach.
6. Elderly care—tags on objects can be monitored to ensure that a person has performed his or her daily routine activities.
7. Monitoring children in the house or other location—to ensure they avoid dangerous or off-limits areas.

In one approach, a location system according to the invention is an acoustic/ultrasound location system, containing a single base station unit 120 per room and one or more low-cost acoustic responder tags, such as example tag 140. This system extends upon previous position estimation systems by introducing a bi-directional acoustic request/response communication scheme, which allows the base station to calculate the 3D position of mobile tags in a room. The tags, which can be simple and low-cost, respond to a request signal at an acoustic frequency, which propagates in a medium of air, with a suitably encoded response signal. Acoustic signals include the ultrasound range of about >20 kHz, the low ultrasound range of about 20 kHz-1 MHz, and a part of the low ultrasound range of about 20-100 kHz which has been used in some experiments and is expected to be useful in practice. The human audible acoustic range is from about 0-20 kHz.

While multiple, e.g., at least three, base stations may be used to determine the position of an object based solely on line of sight transmissions between the object and the base stations, a single base station embodiment provides a lower cost. One possibility is for the single base station to determine the location of the tag using the line of sight signal from the tag as well as reflected signals caused by reflections off the walls, ceiling, floor and possible other surfaces in the room. Another possibility is for the base station to use an array of transducers that detect the direction of the line of sight signal from the tag as well as the distance. The approach that uses the reflections results in a lower cost system. In either case, the base station sends an acoustic frequency signal to the one or more tags, after which the one or more tags respond with a response signal at an acoustic frequency. The base station receives this signal, and the reflections, and calculates the location of the tag based on the times at which the signal and the reflections are received, the amplitude characteristics of the received signals, the known propagation speed of the signal, and the known geometry of the room. For the example room 100 of FIG. 1, “a” denotes the path of the line of sight signal transmitted by the tag 140, while “b”, “c” and “d” denote the paths of primary reflections of this signal.

The geometry of the room can be learned in a setup phase, for instance, where the tag transmits a signal to the base station after being positioned in specified locations of the room, or the geometry can be programmed into the base station via an appropriate application running on a PC, for instance, and communicating with the base station 200 via the interface 220.

The configuration described herein results in a low cost tag for a number of reasons. For example, costs are reduced since the location system does not require RF modules in the tags and base station, and clock synchronization between the tags and base station is not necessary. Instead, low cost piezo ultrasound transducers can be used. Drive electronics include a relatively simple low-frequency control and amplifier electronics, at the price of an integrated circuit. Moreover, the tag does not need to calculate its own position, so processing requirements are reduced. Furthermore, acoustic signals provide precise position estimation, while for RF signals, measuring times-of-flight is expensive and complex, and using the signal strength of an RF signal as a measure of distance is known to be unreliable.

Furthermore, the location system can provide an increased functionality by allowing the base station and/or the tags to make use of coded signals to transfer information, such as for the base station to request a certain tag to respond, or to control the tag's behavior, or an associated actuator, or for the tag to transmit coded information back to the base station providing a status of the tag, or data from an associated sensor.

FIG. 2 illustrates a block diagram of a base station and a responder tag, according to the invention. Blocks 205 and 255 read “timer”. Blocks 210 and 260 read “processor”. Blocks 212 and 262 read “memory”. Blocks 215 and 265 read “power source”. Block 270 reads “sensor”. Block 280 reads “actuator”. The base station 200 includes a processor 210, memory 212, timer 205, power source 215, transmitter 225, receiver 230 and amplifier 232 for amplifying received signals. The tag or mobile device 250 may also include a processor 260, memory 262, timer 255, power source 265, transmitter 275, receiver 280, and amplifier 252 for amplifying received signals. The transmitters 225 and 275 and receivers 230 and 280 in each case may operate at an acoustic frequency.

The memories 212 and 262 may store instructions, such as software, micro-code or firmware, which are executed by the respective processors 210 and 260 to achieve the functionality described herein. The memories 212 and 262 may thus be considered to be program storage devices that tangibly embody the executable instructions. The memory 212 may also store other data as needed such as samples of a received signal 400, the times of arrival of the line-of-sight signal and reflections for one or more tags, previous/current 3D positions of tag(s), reliability of position estimates, a log of sensor readings, and so forth. The power source 215 for the base station may be AC power or a battery, while the power source 265 for the tag 250 should generally be a battery, or other component to power a wireless device, such as solar power, fuel cell, etc., to allow the tag to be mobile in the room. The timer 205 of the base station 200 is used to determine an elapsed time between transmission of a request signal and receipt of a response signal from a tag, including the line of sight signal and reflections thereof. The timer 255 of the tag 250 is used to implement a delay between receipt of the request signal from the base station, e.g., the line of sight request signal, which is received before any reflections, and a transmission of the response signal by the tag. The timers 205 and 255 need not be separate components but can be provided by the respective processors 210 and 260. The timer 255 can be any means that can provide a pre-designed fixed delay imposed by the sequence of decoding-processing-signal transmission. The transmitters 225 and 275 and receivers 230 and 280 could optionally be combined into respective transducers for the base station 200 and the tag 250. Such transducers are able to switch between a transmitting and a receiving state. An interface 220 allows the base station to communicate with other devices, such as other base stations, or a personal computer or other device on which an application is running and using the location data provided by the base station 200. For example, the base station may send data regarding received signals to a PC, which performs calculations using the data for determining the location of the tag. Furthermore, one or more sensors 270 and actuators 280 may be associated with the tag 250.

FIG. 3 illustrates a timing diagram 300 for acoustic signals transmitted by the base station (BS) and the responder tag or mobile device (MD) of FIG. 2, according to the invention. One possible operation sequence of the location system will now be described step by step, by going through a complete cycle of one position estimate for one tag.
1. The base station (BS) decides which tag it needs to locate, assuming multiple tags are present in the room. This can be decided, e.g. based upon the needs of the applications that make use of the location information. Furthermore, a tag may be queried when a predefined time period has passed since a previous query, or based on a prediction that the tag is most likely to have moved the most distance, compared to other tags, since the last query of the tag.
2. The base station sends out an acoustic request signal, represented by arrow 310, at time t₀. Reflections of the request signal, represented by arrows 320, are not used by the tag. When multiple tags are present, the request signal may also be encoded with an identifier of the tag to be queried signal, e.g., using any existing modulation techniques such as ASK, FSK, BPSK, CDMA and so forth. After the transmission, the base station immediately switches to a receive mode and waits for a response signal from the queried tag. The base station also starts the timer 205 at time to record the time that elapses until the arrival of the response signal from the tag and its reflections. The request signal may be modulated or encoded with additional information, as discussed further below.
3. Upon reception of the request signal from the base station, all tags that are ‘awake’, i.e., not in a low-power ‘sleep’ mode, start receiving and decoding the request signal. In one approach, for only one tag T that receives the signal at time t₁, the decoded identifier matches the tag's own identifier. All other tags ignore the request signal. Tag T prepares to respond to the base station with a response signal.
4. Tag T responds with a response signal, represented by arrow 330, at time t₂, after a fixed delay t_{del}=t₂−t₁ implemented by the timer 255. The response signal may be a simple and low-energy acoustic pulse. Or, information can be modulated or encoded into the response signal, as discussed further below.
5. The response signal propagates throughout the room, first reaching the base station at time t₃. The base station, which was waiting for the response, records the response signal, y, starting at time t₃. The signal y includes subsequent reflections, represented by arrows 340, of the tag's response. The base station's timer 205 is stopped at time t₃, the moment that the first (line-of-sight) signal component of the response arrives.
6. The base station decodes from y the coded information sent by the tag, if there is any.
7. The base station calculates the absolute distance between itself and the tag using d=c·(t₃−t₀−t_{del})/2, where c is the speed of sound in m/s, t₃ and t₁ are defined as discussed above, and t_{del}=t₂−t₁ is the fixed predefined time delay, such as implemented by the timer 255, between the time the tag receives the request signal and time it responds by transmitting its response signal.

Using the distance d and a pattern of acoustic reflections within the recorded signal y, the base station calculates the position of the tag. For example, one of the methods described in PCT publication WO 2004/095056, published Nov. 4, 2004, (docket no. PHNL030395EPP), or E. O. Dijk, Indoor Ultrasonic Position Estimation Using A Single Base Station, Technische Universiteit Eindhoven (2004), ISBN 90-386-0912-4, both of which are incorporated herein by reference, may be used. For instance, a signature matching method may be used in which a time-series signature of the signal and its reflections received by the base station is matched to pre-stored model signatures or templates. For example, FIG. 4a illustrates an ultrasound signal as detected by a base station receiver. The signal transmitted by the tag reflects off the walls, floor and/or ceiling, and possibly other objects in a room, and travels towards the base station's receiver as the signal 400 with amplitude A. At the base station, filtering can be used to remove noise outside a frequency band of interest, along with demodulation and analog to digital conversion. The signal includes a first peak 412, which may be the line of sight portion, at time t1, and the reflected signal portions, including a second peak 414 at time t2, a third peak 416 at time t3 and possibly further reflections of lesser strength. Different signature templates can be provided, such as from simulations or from recording signals from the tags in different known locations of the room, in a database of signature templates that are correlated with different tag locations. The stored signature templates, such as template 420 (FIG. 4b) and template 430 (FIG. 4c), are compared to the received signal 400 using a comparison algorithm to determine which template is the closest match. The location associated with the closest matching template is then taken as the location of the tag. Note that various approaches can be used to narrow down the number of templates that need to be compared to the received signal such as by estimating the current position of a tag based on its previous position and direction of movement.
8. The base station repeats the above cycle for the same or a different tag.

Various types of information may be coded into the response signal sent by the tag, such as:
1. Readings from the associated sensor 270, such as:
   a. Light intensity
   b. Sound level
   c. Amount of movement of the tag
   d. Contact or pressure sensor readings
2. Tag status; tag battery status, e.g., amount of remaining power.
3. Quality of reception of the request signal, e.g., signal to noise ratio, signal power, or relative power of the request signal with respect to the power of a certain reflection of the request signal.

Similarly, various types of information may be coded into the request signal sent by the base station, in addition to a tag identifier, such as:
1. Instructions for tag power management. For instance, the base station can instruct a tag to switch to a lower power mode in which it ‘sleeps’ for a period of time and wakes up for a predefined time interval during which the tag checks whether a request signal is being sent during this interval. Or, the tag can wake up if it is moved, e.g., based on a signal from a motion sensing device. In any case, such a power management scheme can reduce power consumption and the required battery size. See further discussion below regarding “Power management”.
2. Instructions for tag sensors. For instance, the base station can instruct a tag to control the sensor 270, e.g., to perform certain measurements more or less frequently, or to perform different measurements, or to adjust a sensitivity or calibration of the sensor 270.
3. Instructions for tag actuators 280. For instance, the base station can instruct a tag to control an actuator such as a light to make it blink, or control an actuator such as an audible device to make a sound that a person can hear, e.g., to locate a missing object.

Power Management

To reduce power consumption, the responder tag can be kept in a low-power sleep state most of the time. In this approach, the tag periodically wakes up and polls its embedded receiver to determine if any transmission from the base station is present. If a transmission is present, the tag switches from the low-power state to a normal operation state, and starts recording the signal. Or, the tag can record any signals, which may include one or more coded ultrasound transmissions, for a defined time period. The transponder tag thus does not have to be ‘on’ listening to the base-station signals all the time. For example, the tag can wake up every 200 ms to listen for a period of 1 ms. Therefore, the tag can be asleep 995/1000 of the time, which saves power considerably. The base-station can wake up the tag by sending a continuous ultrasound signal for at least 200 ms, which will be detected by the tag. The tag will wake up for at least, e.g., 100 ms. In this time, the base-station sends an encoded request signal into the room which is received by the tag in the 100 ms time window and decoded. Thereafter, the tag will send a response to the base station as described and go back to the low power ‘sleep’ mode. During the low-power state, the tag is only powering a low-power (e.g., microwatts) wake-up circuit with a timer. This circuit activates the tag back into normal operation mode after a predefined time interval, e.g. 200 ms, in the above example.

Alternative Method for Power Management

An alternative power management technique involves using a tag that is always in a low-power state if there are no acoustic signal transmissions in the room. The tag has a low-power wake-up circuit in processor (260) that monitors the receiver (280) continuously, by means of a low-power (e.g., microwatts) amplifier 252 connected to receiver (280), which amplifies the signal from the ultrasonic receiver transducer. If a sufficient signal is detected (with a threshold and/or current integration circuit), the tag's microprocessor can be switched from the low-power sleep mode to the normal operation mode.

Coded Tag Response

In this approach, more than one tag can be queried simultaneously by the base station. The tags respond by encoding their identity in a suitable way into the signal, such that the base station can separate the coded signals received from various tags at the same time. For instance, code-division, multiple access (CDMA) encoding may be used. In one approach, the base station sends a general request for all tags to respond. Or, the request may be encoded with the identifiers of two or more tags. After decoding the signal y into n separate signals y₁, y₂, etc. for each of the tags, the position estimation can be performed for each tag i using its signal yᵢ. A benefit of this approach is that the overall update rate of the system can be improved since more tags can simultaneously be queried by the base station. Moreover, this coded response may be combined with the other types of encoded information mentioned above.

Query Rate of Tag Location Estimates

The update rate of location estimates for tags depends on the number of tags in the system. Although there may be many (e.g., >>10) tags in a system, it does not mean that the position of each one should be monitored. Tags that are inactive or lying still may be skipped or queried less frequently by the base station, e.g. based on previous information the base station has about the movement of tags, while faster moving tags can be queried more often.

From experiments it is known that in an indoor environment a typical short (<=1 ms) ultrasonic signal of 40 kHz sent at a time t=0, becomes undetectable amidst noise approximately at a time t=100 ms or earlier. Considering that one request-response involves two transmissions, one from the base station and one from a tag, a position estimation cycle for a tag takes roughly 200 ms at most. Therefore, at least five position updates per second are possible. For N tags moving around, the average location update rate per tag becomes 5/N updates per second. This performance may be improved by using coded tag responses, such as using CDMA, as mentioned above. Because typically not all tags will be moving at the same time, this should provide an acceptable performance for a location system in a single room.

Acoustic Array for Enhanced Position Estimation

The base-station can use an array of two or more ultrasound transducers to detect extra information in the acoustic response signal from the tag. A simple instance of this broader idea was described in Netherlands patent application no. 04100950.7, filed Mar. 9, 2004, (docket no. PHNL040132EPP), incorporated herein by reference. With such an array of ultrasound transducers (in receive mode) the direction of the incoming ultrasound direct line-of-sight signal and the direction of the incoming reflection signals from the tag can be estimated. This information can help in determining the 3D position of the tag. The use of acoustic arrays in general is well known in the literature. See, for example, L. J. Ziomek, Fundamentals of Acoustic Field Theory and Space-Time Signal Processing, CRC press (1995). Furthermore, a combination of reflections with arrays is briefly described in section 8.3.3 of the above-referenced E. O. Dijk publication entitled “Indoor Ultrasonic Position Estimation Using A Single Base Station”.

Combining Acoustic Reflections with Position Tracking

This idea is described in the above-referenced E. O. Dijk publication at page 173. It can significantly improve robustness/accuracy of 3D position estimates, based on ultrasonic reflections.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A location system, comprising:
a base station (120, 200) arranged in an at least partially bounded 3D space (100), and including a transmitter (225), a receiver (230), and a timer (205);
a responder tag (140, 250) associated with an object to be located in the at least partially bounded 3D space, and including a transmitter (275), a receiver (251), and a timer (255); wherein:
the transmitter of the base station transmits a first wireless signal (310) for instructing the responder tag to respond;
the first wireless signal comprises an acoustic signal;
the receiver of the responder tag receives the first wireless signal, the timer (255) of the responder tag is responsive to receipt of the first wireless signal for determining when a predefined period of time has elapsed since the receipt of the first wireless signal, and the transmitter (275) of the responder tag is responsive to the timer of the responder tag for transmitting a second wireless signal (330) after the predefined period of time has elapsed;
the second wireless signal comprises an acoustic signal;
the second wireless signal, and reflections thereof (340) within the at least partially bounded 3D space, are received by the receiver of the base station at different times; and
a location of the responder tag in the at least partially bounded 3D space is determined by using the timer of the base station, and based on times of receipt of the second wireless signal, and the reflections thereof.

2. The location system of claim 1, wherein:
the timer of the base station notes a time (t0) of the transmission of the first wireless signal; and
the base station determines the location of the responder tag based on elapsed times between the time of the transmission and the times of receipt (t3).

3. The location system of claim 1, wherein:
a plurality of respective responder tags are associated with respective objects to be located in the at least partially bounded 3D space;
each of the plurality of respective responder tags has an associated identifier; and
the first wireless signal is encoded with the associated identifier of a particular one of the responder tags for instructing the particular one of the responder tags to respond.

4. The location system of claim 1, wherein:
the second wireless signal is encoded with data indicating a status of the responder tag.

5. The location system of claim 4, wherein:
the second wireless signal is encoded with data indicating a status of a battery (265) of the responder tag.

6. The location system of claim 1, wherein:
the second wireless signal is encoded with data indicating a quality of the first wireless signal as received by the receiver of the responder tag.

7. The location system of claim 1, wherein:
the first wireless signal is encoded with data for controlling a power management setting in the responder tag.

8. The location system of claim 1, wherein:
the first wireless signal is encoded with data for controlling an operation of a sensor (270) associated with the responder tag.

9. The location system of claim 1, wherein:
the first wireless signal is encoded with data for controlling an operation of an actuator (280) associated with the responder tag.

10. The location system of claim 1, wherein:
a plurality of respective responder tags are associated with respective objects to be located in the at least partially bounded 3D space;
each of the plurality of respective responder tags has an associated identifier; and
the first wireless signal is encoded with the associated identifiers of at least two of the plurality of respective responder tags for instructing the at least two of the plurality of respective responder tags to respond.

11. The location system of claim 1, wherein:
a plurality of respective responder tags are associated with respective objects to be located in the at least partially bounded 3D space; and
at least two of the plurality of respective responder tags respond to the first wireless signal by transmitting respective wireless signals using CDMA encoding.

12. The location system of claim 1, wherein:
the second wireless signal is encoded with data from a sensor (270) associated with the responder tag.

13. The location system of claim 12, wherein:
the data from the sensor indicates a light intensity.

14. The location system of claim 12, wherein:
the data from the sensor indicates a sound level.

15. The location system of claim 12, wherein:
the data from the sensor indicates an amount of movement of the responder tag.

16. A base station in a location system arranged in an at least partially bounded 3D space, comprising:
a transmitter (225);
a receiver (230); and
a timer (205); wherein:
the transmitter transmits a first wireless signal (310) for instructing a responder tag (140, 250) in the at least partially bounded 3D space (100) to respond;
the first wireless signal comprises an acoustic signal;
the responder tag transmits a second wireless signal (330) a predefined period of time after receipt of the first wireless signal;
the second wireless signal comprises an acoustic signal;
the receiver receives the second wireless signal, and reflections thereof (340) within the at least partially bounded 3D space, at different times; and
a location of the responder tag in the at least partially bounded 3D space is determined using the timer, and based on times of receipt of the second wireless signal, and the reflections thereof.

17. The base station of claim 16, further comprising:
a processor (210) for implementing an algorithm for determining the location of the responder tag in the at least partially bounded 3D space, using the timer, and based on the times of receipt of the second wireless signal, and the reflections thereof.

18. The base station of claim 16, wherein:
the timer (205) of the base station notes a time (t0) of the transmission of the first wireless signal; and
the base station determines the location of the responder tag based on elapsed times between the time of the transmission and the times of receipt (t3).

19. A responder tag in a location system associated with an object to be located in an at least partially bounded 3D space, comprising:
a transmitter (275);
a receiver (251); and
a timer (255); wherein:
the receiver receives a first wireless signal (310) from a base station instructing the responder tag to respond;
the first wireless signal comprises an acoustic signal;
the timer is responsive to receipt of the first wireless signal for determining when a predefined period of time since the receipt of the first wireless signal has elapsed;
the transmitter is responsive to the timer for transmitting a second wireless signal (330) after the predefined period of time has elapsed;
the second wireless signal comprises an acoustic signal;
the second wireless signal, and reflections thereof (340) within the at least partially bounded 3D space, are received by the base station at different times; and
a location of the responder tag in the at least partially bounded 3D space is being determined based on times of receipt of the second wireless signal at the base station, and the reflections thereof.
